(19) United States
(12) Patent Application Publication
(10) Pub. No.: US 2012/0140608 A1
(43) Pub. Date: Jun. 7, 2012

(54) METHOD FOR DETECTING OBLIQUITY OF OPTICAL DISC DRIVE BASED ON FUNCTION BETWEEN OBLIQUITY AND CENTRAL ERROR SIGNAL BIAS

(76) Inventors: Chih-Bo Lin, Taoyuan County (TW); Song-Ruei Chen, Taoyuan County (TW)

(21) Appl. No.: 13/306,995

(22) Filed: Nov. 30, 2011

(30) Foreign Application Priority Data
Dec. 2, 2010 (TW) 099142007

(51) Int. Cl. G11B 20/22

(52) U.S. Cl. 369/53.19; G9B/20.061

(57) ABSTRACT

A method for detecting an obliquity of an optical disc drive is disclosed. The method includes the following steps: setting up and storing a function between the obliquity and a central error signal bias by performing a current level calibration upon a plurality of obliquities of the optical disc drive predetermined to be tested to obtain corresponding central error signal biases; performing the current level calibration upon an objective lens of the optical disc drive; obtaining a calibrated central error signal bias; and acquiring the obliquity of the optical disc drive by interpolating or extrapolating the calibrated central error signal bias according to the stored function between the obliquity and the central error signal bias.

### BACKGROUND OF THE INVENTION

1. Field of the Invention

The present invention relates to an optical disc drive for reading/writing an optical disc, and more particularly, to a method for detecting an obliquity of the optical disc drive when servo parameters need to be modified in response to the obliquity of the optical disc drive.

2. Description of the Prior Art

In order to meet the application and space demand of various electronic products, an optical disc drive often needs to be installed at different obliquities, which causes the variation of gravity acting on the optical disc drive and then changes the servo performance of the optical disc drive, thus affecting the high-speed read/write accuracy of the optical disc drive.

As shown in FIG. 1, a pick-up head 10 of a conventional optical disc drive has elastic metal wires 12 extending individually from two sides of a base 11 and supporting an objective lens set 13 equipped with a magnetic block to float beside a nearby solenoid 14. A microprocessor 15 adjusts the magnitude and the direction of the magnetic control force of the solenoid 14 to resist the elastic force of the metal wires 12 through a servo unit 16, and drives the objective lens set 13 to move. Therefore, a laser beam emitted from the pick-up head 10 is aligned and then projected to an optical disc (not shown), and a reflective beam from the optical disc is received by the objective lens set 13 for focus servo control, tracking servo control, and data signal generation.

Because the general optical disc drive is horizontally disposed, the control parameters are therefore adjusted based on the horizontal placement setting. In a case where the optical disc drive is tilted toward either side, gravity T acting on the objective lens set 13 not only resists the motion of the objective lens set 13, but also makes the solenoid 14 unable to achieve the normal control performance unless the gravity T is counteracted. Meanwhile, the objective lens set 13 resists the elastic force of the metal wires 12 with the gravity T acting on itself, which causes the objective lens set 13 to deviate from the optical balance position in the horizontal direction to a deviated position 13a or 13b. The adjusted and calibrated control parameters of the optical disc drive are no longer suitable and have to be adjusted and calibrated again based on the obliquity of the optical disc drive. Therefore, in order to detect the obliquity of the optical disc drive for adjusting the control parameters, a mechanical sensor is utilized in the conventional optical disc driver to detect whether the conventional optical disc driver is horizontally or vertically disposed. However, the mechanical sensor needs bigger allocation room and increases the production cost.

As disclosed in U.S. Pat. No. 7,532,552, in order to determine if the optical disc drive is horizontally or vertically disposed, the time the objective lens set spent in reaching the predetermined distance is measured by supplying the predetermined control force. However, the detection procedure is not simplified enough and fails to determine the obliquity of the optical disc drive. As a result, it is still unable to adjust the control parameters correctly based on the various effects caused by the obliquity of the optical disc drive. Therefore, the conventional optical disc drive still has the problem of detecting the obliquity of the optical disc drive, and the problem needs to be resolved.

### SUMMARY OF THE INVENTION

It is one objective of the present invention to provide a method for detecting an obliquity of an optical disc drive. The obliquity of the optical disc drive is determined based on a central error signal bias of the optical disc drive.

It is another objective of the present invention to provide a method for detecting an obliquity of an optical disc drive. By setting up a function between the obliquity of the optical disc drive and a central error signal bias, the procedure of detecting the obliquity of the optical disc drive is simplified and accelerated.

In order to achieve the above objectives, the present invention provides a method for detecting an obliquity of the optical disc drive. The method for detecting the obliquity of the optical disc drive includes the following steps: setting up and storing a function between the obliquity and a central error signal bias by performing a current level calibration upon a plurality of obliquities of the optical disc drive predetermined to be tested to obtain corresponding central error signal biases; performing the current level calibration upon an objective lens of the optical disc drive; obtaining a calibrated central error signal bias; and acquiring the obliquity of the optical disc drive by performing interpolation or extrapolation according to the calibrated central error signal bias and the stored function between the obliquity and the central error signal bias.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a pick-up head of a conventional optical disc drive.

FIG. 2 is a diagram illustrating an optical system of a pick-up head.

FIG. 3 is a diagram illustrating the generation of a central error signal bias.

FIG. 4 is a diagram illustrating the tilt generation in an optical disc drive.

FIG. 5 is a diagram illustrating the movement of an optical system of a pick-up head in the optical disc drive.

FIG. 6 is a diagram illustrating relationship between an obliquity of an optical disc drive and a CE signal bias according to an embodiment of the present invention.

FIG. 7 is a flowchart illustrating a method of setting up a function between an obliquity of an optical disc drive and a CE signal bias according to an embodiment of the present invention.

FIG. 8 is a flowchart illustrating a method for detecting an obliquity of an optical disc drive according to an embodiment of the present invention.

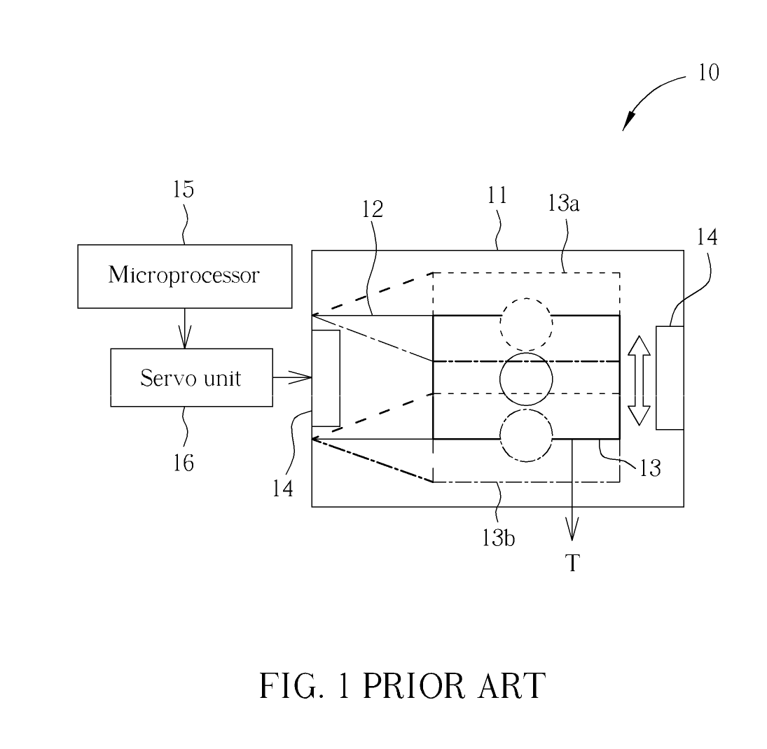

### DETAILED DESCRIPTION

With regard to technical means and utilities thereof used to achieve the above objectives of the present invention, preferred embodiments are described as follows by way of examples and with reference to the accompanying diagrams.

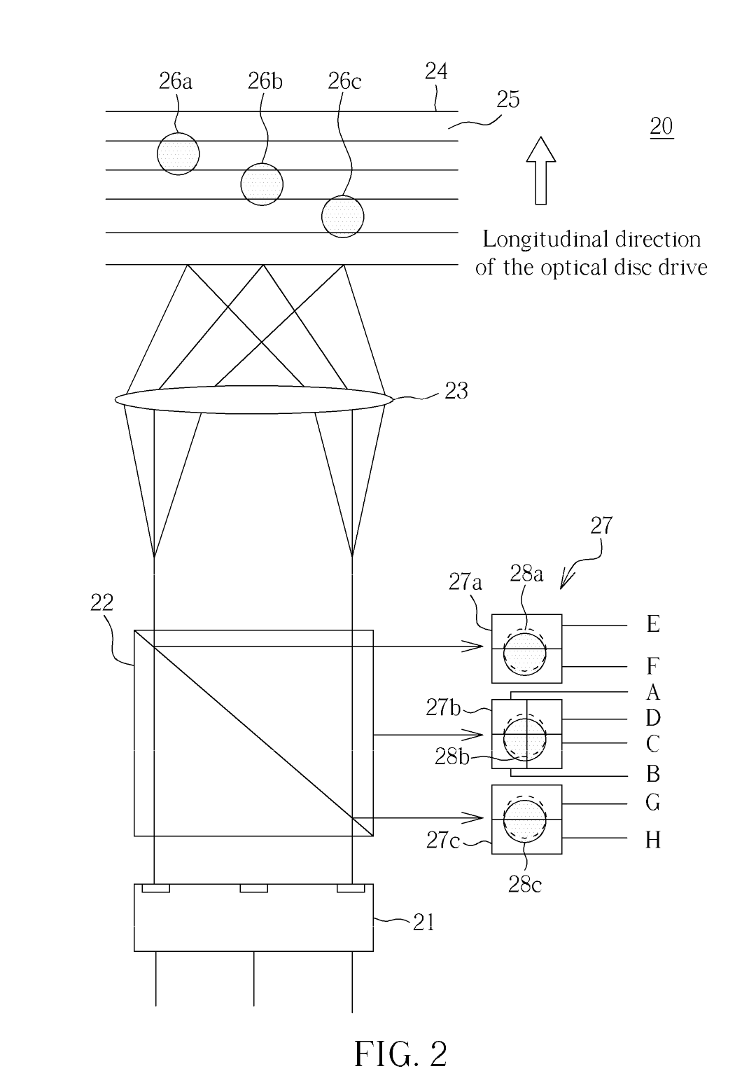

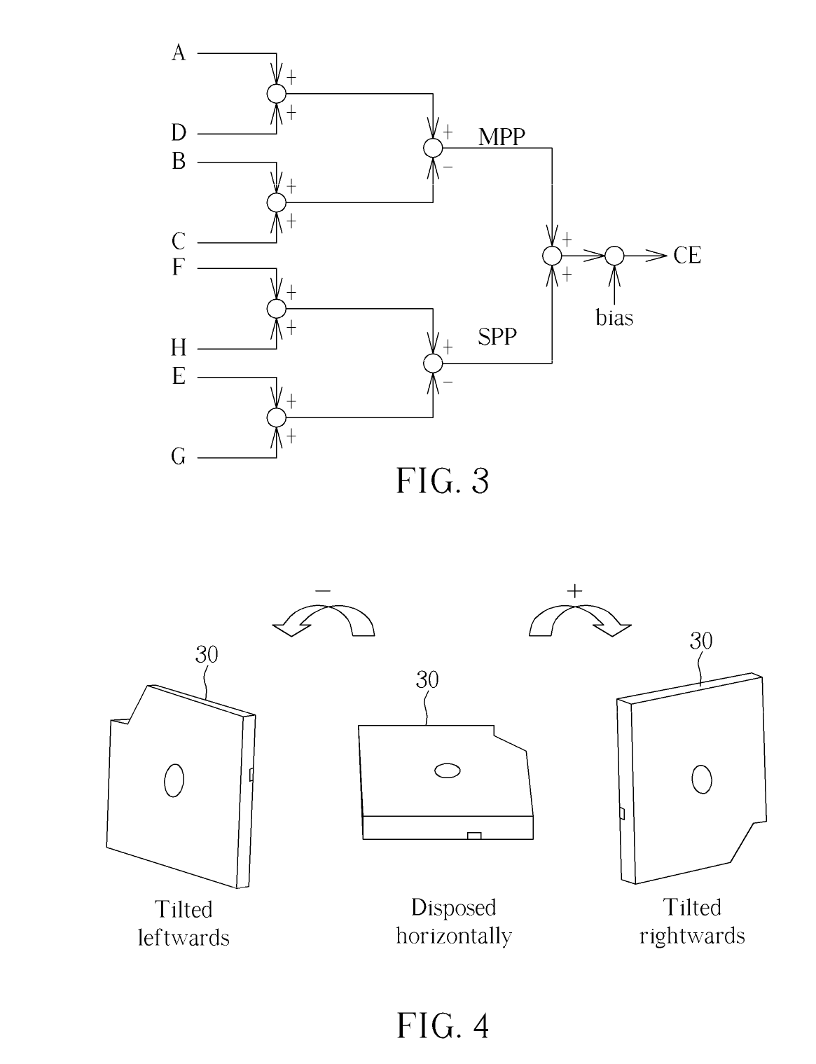

Please refer to FIG. 2 together with FIG. 3. FIG. 2 is a diagram illustrating an optical system of a pick-up head, and FIG. 3 is a diagram illustrating the generation of a central error signal bias in the pick-up head. Taking a three-optical-beam optical system of a pick-up head 20 for example, three optical spots 26a, 26b, and 26c are formed by mainly utilizing a laser diode 21 to generate three optical beams to pass through an optical device 22, and using an objective lens 23 to focus the three optical beams onto a data track 25 of an optical disc 24. Next, the optical disc 24 reflects the three optical spots 26a, 26b, and 26c to the objective lens 23, and the three optical spots 26a, 26b, and 26c are totally reflected through the optical device 22 to an optical transducer 27, wherein the optical transducer 27 converts reflected light into electrical signals based on the intensity of the reflected light. The optical transducer 27 includes three sub-optical transducers 27a, 27b, and 27c, which receive reflected optical spots 28a, 28b, and 28c of the three optical spots 26a, 26b, and 26c, respectively. The first sub-optical transducer 27a is composed of receiving parts E and F, the second sub-optical transducer 27b is composed of receiving parts A, B, C, and D, and the third sub-optical transducer 27c is composed of receiving parts G and H. The optical transducer 27 receives the reflected light and converts optical signals of the received light, received by the receiving parts A-H, into a central error signal (abbreviated as CE signal), which represents that the objective lens 23 deviates from the center of the pick-up head 20. In other words, the CE signal is equal to [(A+D)−(B+C)]+[(E+G)−(F+H)].

Because there are manufacturing errors in components of the optical disc drive, the objective lens 23 of the optical disc drive, horizontally disposed after assembly, cannot be aligned with the center of the pick-up head 20, thus making the CE signal fail to return to zero and affecting the accuracy of moving the objective lens 23 by the pick-up head 20. Therefore, a current level (i.e., DC level) calibration is needed. The DC level calibration is to adjust a current utilized by a servo unit to control a solenoid, thereby moving the objective lens 23 to the center of the pick-up head 20, and setting the CE signal to zero. The center of the pick-up head 20 is then set as the starting point where the objective lens 23 moves from. As the variation of the CE signal, resulting from the DC level calibration setting the CE signal to zero, is known as a CE signal bias, there is a certain ratio between the CE signal bias and the distance of the objective lens 23 deviated from the center of the pick-up head 20.

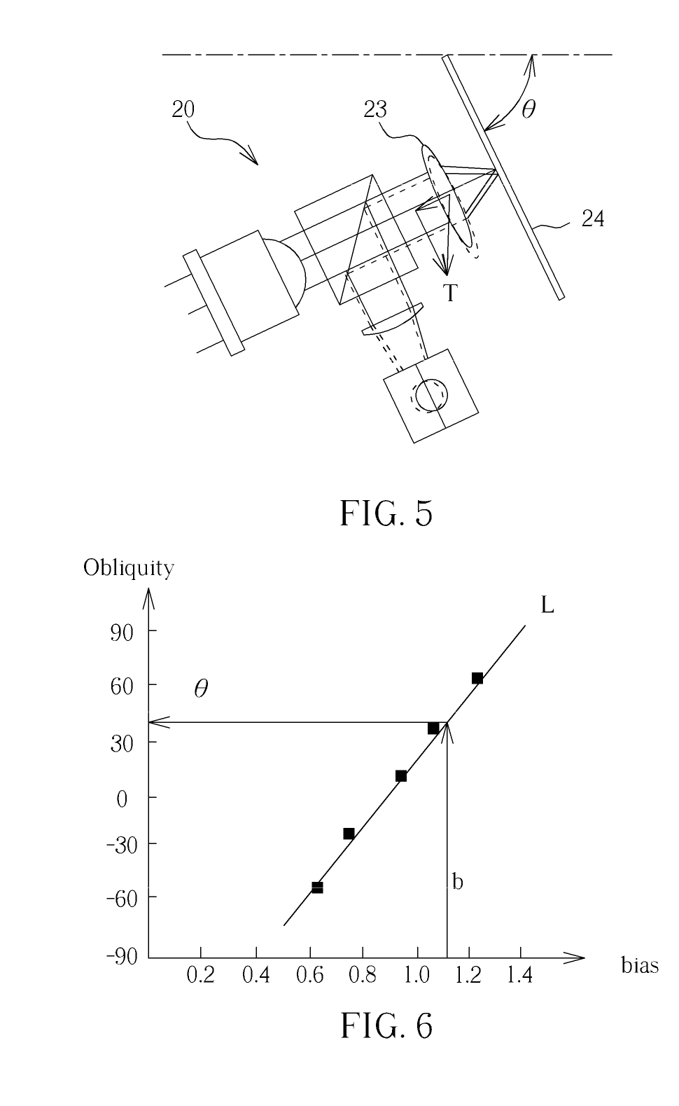

Please refer to FIG. 4 and FIG. 5. FIG. 4 is a diagram illustrating the tilt generation in an optical disc drive, and FIG. 5 is a diagram illustrating the movement of an optical system of a pick-up head in the optical disc drive. Generally, the optical disc drive 30 is horizontally disposed, that is, an optical disc 24 is horizontally placed, and a pick-up head 20 projects the light beam below the optical disc 24 onto the optical disc 24 for reading/writing data. In a case where the optical disc drive 30 is horizontally disposed, the gravity T acting on the objective lens 23 is all vertically downward to the optical disc 24, and only makes the objective lens 23 move in a vertical direction without inducing deviation in the objective lens 23. However, in a case where the optical disc drive 30 is tilted leftwards and rightwards with an obliquity θ, the gravity T acting on the objective lens 23 induces a component force parallel to the optical disc 24, and resists the elastic metal wires supporting the objective lens 23, resulting in the deviation in the objective lens 23 represented as dashed line as shown in FIG. 5. Because the component force of the gravity T acting on the objective lens 23, which is parallel to the optical disc 24, varies with the obliquity θ, when the obliquity θ is larger, the component force (parallel to the optical disc 24) is larger, and thus the distance that the objective lens 23 deviated from the pick-up head 20 is farther. Besides, there is a certain ratio between the obliquity θ and the deviated distance. Therefore, during the current level calibration, the CE signal bias increases as the deviated distance increases.

FIG. 6 is a diagram illustrating relationship between an obliquity of an optical disc drive and a CE signal bias according to an embodiment of the present invention. In this embodiment, the relationship between the obliquity of the optical disc drive and the CE signal bias needs to be set up before the obliquity of the optical disc drive is detected. The optical disc drive is rotated with a plurality of obliquities in sequence to perform the current level calibration. For example, the optical disc drive is rotated with obliquities of −60°, −30°, 0°, 30°, and 60°, wherein the obliquity is designated to be positive when the optical disc drive is rotated clockwise. CE signal biases corresponding to the obliquities of the optical disc drive are measured respectively and plotted in a coordinate diagram illustrating the relationship between the obliquity and the CE signal bias, thereby setting up a function such as a linear function L which is linearly approximated. Therefore, after an optical disc drive has been disposed, in detecting obliquity of the optical disc drive, an obliquity θ may be acquired rapidly by interpolation or extrapolation performed according to a CE signal bias obtained from the current level calibration and the linear function L, which is obtained from the tested and pre-stored relationship between the obliquity and the CE signal bias. In this way, the control parameters of the optical disc drive may be adjusted correctly based on the obliquity θ.

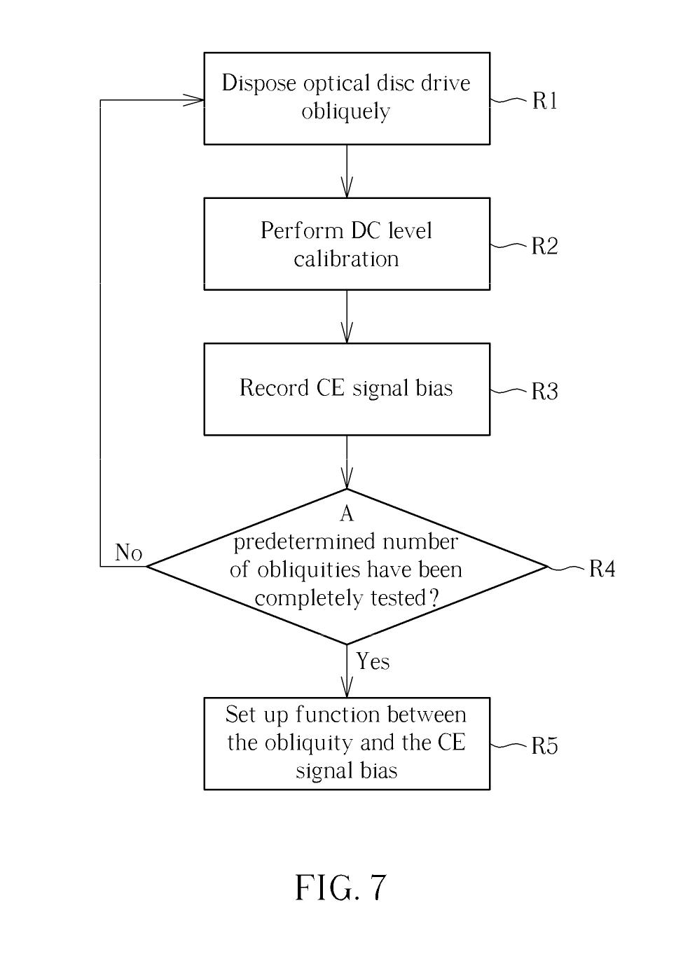

FIG. 7 is a flowchart illustrating a method of setting up a function between an obliquity of an optical disc drive and a CE signal bias according to an embodiment of the present invention. First, in step R1, the flow disposes the optical disc drive obliquely based on a plurality of obliquities predetermined to be tested. In step R2, the flow performs current level calibration upon the oblique optical disc drive to obtain a CE signal bias. Next, in step R3, the flow records the obtained CE signal bias corresponding to an obliquity of the optical disc drive. In step R4, the flow checks if a predetermined number of obliquities have been completely tested. If not, return to step R1 to continue testing the optical disc drive disposed with another obliquity; otherwise, go to step R5. In step R5, based on the recorded obliquities of the optical disc drive and the corresponding CE signal biases in step R3, the flow sets up the function between the obliquity of the optical disc drive and the CE signal bias, where the determined function will be stored in the optical disc drive.

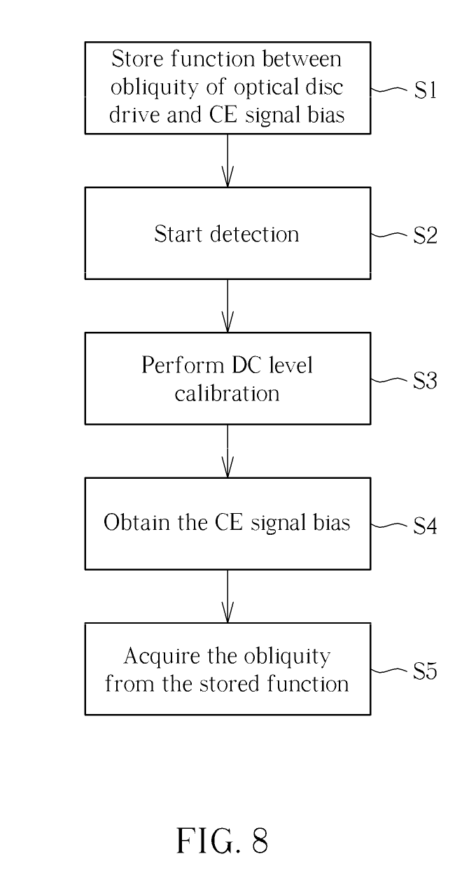

FIG. 8 is a flowchart illustrating a method for detecting an obliquity of an optical disc drive according to an embodiment of the present invention. The steps of detecting the obliquity of the optical disc drive are detailed as follows. First, in step S1, the flow stores a function between the obliquity of the optical disc drive and a CE signal bias. In step S2, the flow disposes the optical disc drive and then starts to detect the obliquity of the optical disc drive. Next, in step S3, the flow performs a current level calibration. In step S4, the flow obtains a calibrated CE signal bias. Next, in step S5, according to the calibrated CE signal bias in step R4, the flow acquires the obliquity of the optical disc drive, which corresponds to the calibrated CE signal bias, from the pre-stored function between the obliquity and the CE signal bias.

Therefore, the exemplary method for detecting an obliquity of the optical disc drive sets up and stores a function between the obliquity of the optical disc drive and a CE signal bias by performing a current level calibration upon a predetermined number of obliquities of the optical disc drive to obtain corresponding CE signal biases, and acquires the obliquity of the optical disc drive simply and rapidly by interpolation or extrapolation performed according to a CE signal bias obtained from the current level calibration and the stored function after the optical disc drive is disposed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for detecting an obliquity of an optical disc drive, comprising:
(a) storing a function between the obliquity of the optical disc drive and a central error signal bias;
(b) performing a current level calibration upon an objective lens of the optical disc drive;
(c) obtaining a calibrated central error signal bias; and
(d) acquiring the obliquity of the optical disc drive from the stored function between the obliquity and the central error signal bias according to the calibrated central error signal bias.

2. The method for detecting the obliquity of the optical disc drive of claim 1, wherein the step (a) further sets up the function between the obliquity and the central error signal bias before storing the function.

3. The method for detecting the obliquity of the optical disc drive of claim 2, wherein the function is set up by performing the current level calibration respectively upon a plurality of obliquities of the optical disc drive predetermined to be tested to obtain corresponding central error signal biases, respectively.

4. The method for detecting the obliquity of the optical disc drive of claim 3, wherein the function is linearly approximated as a linear function.

5. The method for detecting the obliquity of the optical disc drive of claim 1, wherein the obliquity of the optical disc drive is acquired by interpolating or extrapolating the calibrated central error signal bias according to the stored function.
